(19) United States
(12) Patent Application Publication
(10) Pub. No.: US 2006/0028561 A1
(43) Pub. Date: Feb. 9, 2006

(54) Digital imaging device

(76) Inventor: Naoki Tsunoda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/195,751

(22) Filed: Aug. 3, 2005

(30) Foreign Application Priority Data
Aug. 3, 2004 (JP) 2004-227315

(51) Int. Cl. H04N 5/262

(52) U.S. Cl. 348/239

(57) ABSTRACT

A digital imaging device having a communication device (13, 17) configured to send a still image file to an image forming device (21) to be directly printed out includes a voice information obtaining device (23) configured to obtain voice information corresponding to the still image file recorded in a recording medium (5, 20), a text conversion device (2) configured to apply a voice recognizing process to the voice information obtained by the voice information obtaining device so as to convert the voice information into text information, a image data composing device (2) configured to compose image data of the text information based on the text information converted by the text conversion device, and a synthesizing device (2) configured to synthesize the image data composed by the image data composing device and the still image file, the communication device sends the still image file synthesized by the synthesizing device to the image forming device to be directly printed out.

### BACKGROUND OF THE INVENTION

1. Filed of the Invention

The present invention relates to a digital imaging device, more particularly, to a digital imaging device having a communication device, which recognizes voice information to compose image data, synthesizes the image data and a still image file to be printed out.

2. Related Art Statements

Conventionally, as a photographing method of an image processing device and digital camera, there has been proposed a method for recording various information such as text information and voice information together with a photographed image. The information attached to the image is transferred to a personal computer (PC) and the like to be used as information for performing various post-processing. In addition, there has been proposed a direct-printing technology for directly printing an image, which is photographed by an image processing device and a digital camera, by a printer as an external device.

In this direct-printing technology, a still image file and the like obtained by an image processing device and a digital camera are directly printed out by a printer without using a normal PC and the like, and thereby improving convenience of printing out. In a related art for composing a document from voice information disclosed in JP-A-2002-41502, digital image data and voice data collected by a user from a mobile information device such as a digital camera, PDA and portable personal computer having a camera in a destination site is sent through a network, and then the data is received by a server for performing data processing.

Moreover, in the server, there has been proposed an art which edits the received digital image data to a predetermined document format, and also pastes the received voice data in a predetermined area of the above document format as a voice code image or a text image. The document to which the image, text and voice code are pasted is stored in a recording medium as a report for a specific purpose, is printed out as a paper document or is sent to a specific site through the network.

In addition, there has been a camera disclosed in JP-A-2000-267176. The camera for recording an image onto a film having a magnetic recording section comprises a microphone for inputting voice and outputting the input voice as voice information, a voice input circuit which converts the voice signal output from the microphone into digital voice information, cross-checks the voice information with voice information previously stored corresponding to a plurality of recording data and outputs the matched recording data, and a magnetic recording circuit and magnetic head for recording the recording data output from the voice input circuit in the magnetic recording section of the above film.

However, in the conventional method for recording voice data with a photographed image, it was necessary to transfer the photographed image having the voice image to a PC and the like so as to conduct various post-processing, and also the direct-printing technology was not integrated to the conventional method. More particularly, the voice data can not be recorded together with the photographed image by the direct-printing technology; thus, the operation becomes complicated.

In the conventional art disclosed in JP-A-2002-41502, it is necessary to edit digital image data and voice data received by a server to a predetermined document format, and also it is impossible to synthesize the digital image data and the voice data by the direct-printing technology.

The conventional art disclosed in JP-A-2000-267176 is for recording an image onto a film having a magnetic recording section. The technology disclosed in JP-A-2000-267176 is not for digitally synthesizing image data and voice data. Accordingly, there is a problem of increasing a film cost because of using a particular film.

### SUMMARY OF THE INVENTION

The present invention has been made in view of the above problems. It is, therefore, an object of the present invention to provide a digital imaging device which expands voice information attached to a still image file into text information, and synthesizes the text information and a corresponding still image file in an image processing device and a digital camera, so as to improve convenience of a direct-printing technology of the still image file to which the voice information is attached.

In order to solve the above problems, according to one embodiment of the present invention, a digital imaging device including a communication device configured to send a still image file to an image forming device to be directly printed out comprises a voice information obtaining device configured to obtain voice information corresponding to the still image file recorded in a recording medium, a text conversion device configured to apply a voice recognizing process to the voice information obtained by the voice information obtaining device so as to convert the voice information into text information, an image data composing device configured to compose image data of the text information based on the text information converted by the text conversion device, and a synthesizing device configured to synthesize the image data composed by the image data composing device and the still image file, wherein the communication device sends the still image file synthesized by the synthesizing device to the image forming device to be directly printed out.

In one embodiment of the present invention, the voice information is reorganized to convert the voice information into text information, and the image data is generated from the text information. The synthesizing device synthesizes the image data and the still image file, and the synthesized still image file is sent to the image forming device by the communication device to be directly printed out. Therefore, it is easy for a user to know a relationship between the voice information attached to the still image file and the still image file. Thereby the convenience of the direct printing of the voice information can be improved.

According to one embodiment of the present invention, a digital imaging device including a communication device configured to send a still image file to an image forming device to be directly printed out comprises a voice information obtaining device configured to obtain voice information corresponding to the still image file recorded in a recording medium, a text conversion device configured to apply a voice reorganizing process to the voice information obtained by the voice information obtaining device so as to convert the voice information into text information, an image data composing device configured to compose image data of the text information based on the text information converted by the text conversion device, and a communication device configured to output the image data composed by the image data composing device to an external device, wherein the communication device sends the still image file to the image forming device to be directly printed out after the communication device has sent the image data composed by the image data composing device to the image forming device to be directly printed out.

In one embodiment of the present invention, the voice information is recognized to convert the voice information into the text information, and the image data is generated from the text information. After the image data has been sent to the image forming device to be directly printed out, the still image file is sent to the image forming device to be directly printed out. More particularly, the image data and the still image file are separately printed out. Therefore, it is easy for a user to know a relationship between the voice information attached to the still image file and the still image file. Thereby the convenience of the direct printing of the voice information can be improved. In addition, compared with the above embodiment, the voice information is printed out as another file. Therefore, the relationship of the still image file can be easily known without processing the still image file.

According to one embodiment of the present invention, a digital imaging device including a communication device configured to send a still image file to an image forming device to be directly printed out comprises a voice information obtaining device configured to obtain voice information corresponding to a plurality of still image files recorded in a recording medium, a text conversion device configured to apply a voice recognizing process to the plurality of voice information obtained by the voice information obtaining device so as to convert the plurality of voice information into the text information, an image data composing device configured to compose image data of the text information based on the plurality of text information converted by the text conversion device, and a synthesizing device configured to synthesize the plurality of image data composed by the image data composing device and the plurality of still image files, wherein the communication device sends all of the plurality of still image files synthesized by the synthesizing device to the image forming device to be directly printed out.

In one embodiment of the present invention, the image data corresponding to the plurality of still image files is composed, the plurality of image data is printed out together with the corresponding still image files. Therefore, it is easy for a user to know all of the relationships between the voice information attached to the plurality of still image files and the still image files. Thereby, the convenience of the direct printing of the voice information can be improved.

According to one embodiment of the present invention, a digital imaging device including a communication device configured to send a still image file to an image forming device to be directly printed out comprises a voice information obtaining device configured to obtain voice information corresponding to a plurality of still image files recorded in a recording medium, a keyword registering device configured to register a keyword for recognizing voice, a text conversion device configured to apply a voice recognizing process to the voice information obtained by the voice information obtaining device by using the keyword information registered by the keyword registering device so as to convert the voice information into text information, an image data composing device configured to compose image data of the text information based on the text information converted by the text conversion device, and a synthesizing device configured to synthesize the image data composed by the image data composing device and the still image file, wherein the communication device sends the still image file synthesized by the synthesizing device to the image forming device to be directly printed out.

In one embodiment of the present invention, the voice information corresponding to the still image file recorded in the recording medium is obtained to register the keyword for recognizing voice. The voice information is converted into the text information by the voice recognizing process by using the registered keyword information, and the image data is composed from the text information so as to synthesize the composed image data and the still image file as one still image file. The synthesized still image file is directly printed out by the image forming device. Therefore, it is easy for a user to know a relationship between the voice information attached to the still image file and the still image file. Thereby, the convenience of the direct-printing of the voice information can be improved. Compared with the embodiments, since the keywords for recognizing voice are registered, the text information intended by a user can be generated from the voice information.

According to one embodiment of the present invention, a digital imaging device including a communication device configured to send a still image file to an image forming device to be directly printed out comprises a voice information obtaining device configured to obtain voice information corresponding to a plurality of still image files recorded in a recording medium, a text conversion device configured to apply a voice recognizing process to the voice information obtained by the voice information obtaining device so as to convert the voice information into text information, and a sending device configured to send the still image file and the text information converted by the text conversion device, wherein the image forming device includes a synthesizing device configured to synthesize the text information and the still image file, and the image forming device synthesizes the text information and the still image file sent from the sending device by the synthesizing device to print out the synthesized still image file.

In one embodiment of the present invention, the image forming device comprises the synthesizing device configured to synthesize the text information and the still image file, and the synthesizing device synthesizes the text information and the still image file sent by the sending device to be printed by the image forming device. Therefore, it is easy for a user to know a relationship between the voice information attached to the still image file and the still image file. Thereby, the convenience of the direct-printing can be improved. In addition, compared with the above four embodiment, the synthesizing process of the text information expanded from the voice information and the still image file is performed in the printer. Accordingly, the synthesizing process which matches the printer can be performed.

Priority claim

This application claims the benefit of priority to Japanese Application No. 2004-227315 filed on Aug. 3, 2004, which is hereby incorporated by reference.

### BRIEF DESCRIPTION OF THE DRAWINGS

FIG. 1 is a block diagram showing hardware of a digital camera according to one embodiment of the present invention.

FIG. 2 is a block diagram showing hardware of a PDA device according to one embodiment of the present invention.

FIG. 3 is a block diagram illustrating software of a digital camera 200 according to one embodiment of the present invention.

FIG. 4 is a block diagram illustrating software of the digital camera 200 according to one embodiment of the present invention.

FIG. 5 is a view showing a printed example according to a first embodiment of the present invention.

FIG. 6 is an operation flowchart according to the first embodiment of the present invention.

FIGS. 7A, 7B are views showing printed examples according to a second embodiment of the present invention.

FIG. 8 is a flowchart according to the second embodiment of the present invention.

FIG. 9 is a view illustrating a printed example according to a third embodiment of the present invention.

FIG. 10 is a flowchart according to the third embodiment of the present invention.

FIG. 11 is a view illustrating a printed example according to a fourth embodiment of the present invention.

FIG. 12 is a view showing a keyword table for recognizing voice according to the fourth embodiment of the present invention.

FIG. 13 is a flowchart according to the fourth embodiment of the present invention.

FIG. 14 is a flowchart according to a fifth embodiment of the present invention.

### DETAILED DESCRIPTION OF THE PREFERRED EMBODIMENTS

Hereinafter, the present invention will be specifically described by using embodiments shown in FIGs. However, structural elements, types, combinations, figures and the relative configurations are simple explanation examples. Therefore, the range of the present invention is not limited thereto unless a specific explanation is given.

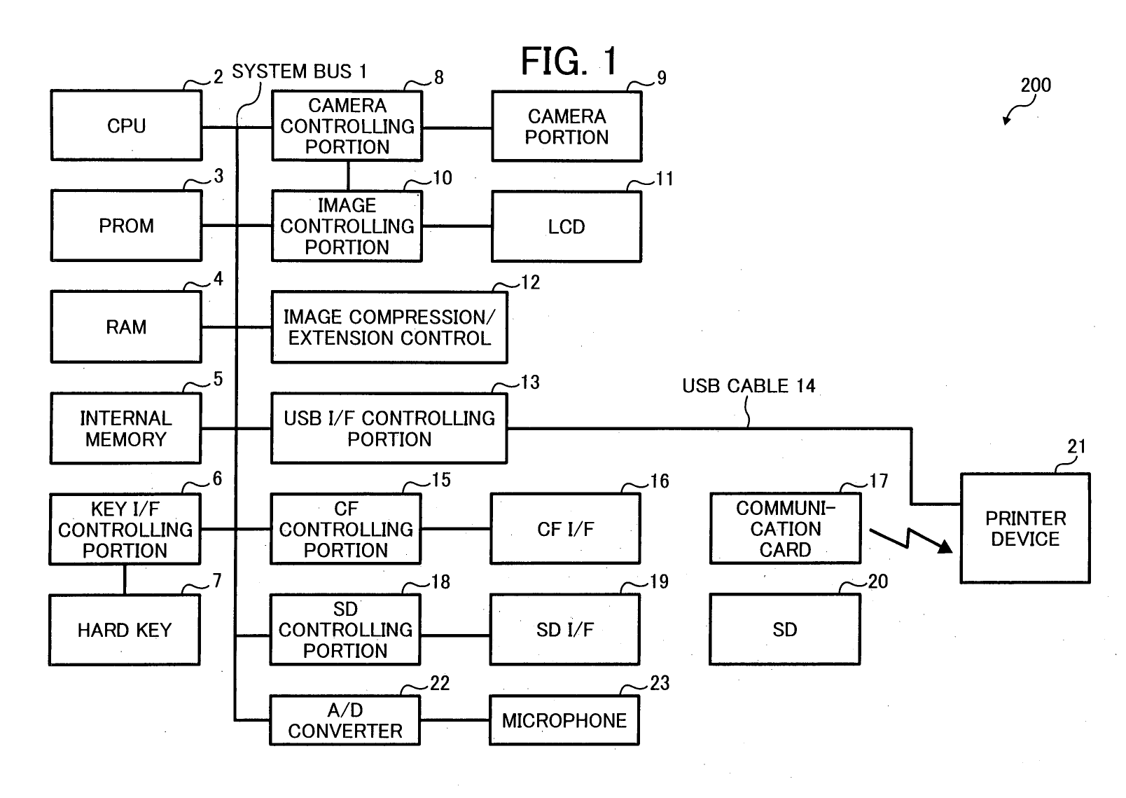

FIG. 1 is a block diagram of hardware of a digital camera according to one embodiment of the present invention. A digital camera 200 comprises a SYSTEM BUS 1, a CPU (text conversion device, image data composing device, synthesizing device) 2 for controlling the whole, a PROM 3 for storing a program, a RAM 4 as a working area of a program and data, an internal MEMORY 5 for storing a photographed image file, system file, data file and the like, a KEY I/F controlling portion 6 for detecting a hard key, a hard KEY 7 such as a shutter and zoom key, a camera portion 9, a camera controlling portion 8 for controlling the camera portion 9, an image compression/extension controlling portion 12 for compressing an image loaded from the camera controlling portion 8 to JPEG (Joint Photographic Experts Group), and decompressing JPEG data stored in a memory, an image controlling portion 10 for outputting the image data from the camera controlling portion 8 and the image data from the image compression/extension controlling portion 12 to an LCD portion 11 as a picture signal, an USB I/F controlling portion (communication device) 13, an USB cable 14 to be connected to a printer device 21, a CF (Compact Flash) controlling portion 15, a CF I/F 16, a communication card (communication device) 17 to be inserted into the CF I/F 16, an SD controlling portion 18, an SD I/F 19, an SD 20 to be inserted into the SD I/F 19, a microphone (voice information obtaining device) 23 for inputting voice and an A/D converter (voice information obtaining device) 22 for converting an analogue voice signal from the microphone 23 to a digital signal. A printer device (image forming device) 21 is connected to the digital camera 200 via the USB cable 14 or the communication card 17.

Next, operations of the digital camera 200 will be described. In normal photographing, the initiation of photographing is reorganized by the hard KEY 7. An image is loaded by the camera portion 9. The image controlling portion 10 converts the image signals output from the camera portion 9 into flame data such as RGB data and YcbCr data, and transfers the image data to the RAM 4 after a required image process has been performed. The transferred image data is compressed to image data such as JPEG by the image compression/extension controlling portion 12, and is again transferred to the RAM 4. The image data such as the JPEG stored in the RAM 4 is recorded in the internal memory 5 or the SD card 20 via the SD controlling portion 18 after a required header process has been conducted.

In addition, voice information is input from the microphone 23 by a voice memo function. The input voice information is converted into digital data by the A/D converter 22, and the digital data is stored in the SD card 20 or the internal memory 5. The stored voice data is controlled as a voice memo. A voice memo can be selected from a plurality of voice memos by an operation of a user. The selected voice memo data is written into a header portion as the voice memo data in a portion for conducting the required header processing of the above photographing process, and then is recorded in the internal memory 5 or the SD card 20 via the SD control portion 18 together with the loaded image information, or the selected voice memo data is recorded in the internal memory 5 or the SD card 20 via the SD control portion 18 as another file as being related to the photographed image when the image information of the above photographing process is recorded in the internal memory 5 or the SD card 20 via the SD controlling portion 18.

In addition, a direct-printing function is for directly printing the still image file stored in the internal memory 5 or the SD card 20 by the printer device 21 via the communication card 17 inserted into the CF I/F 16 or the USB cable 14 without using a PC and the like. Moreover, the communication card 17 inserted into the CF I/F 16 can be incorporated into the digital camera as a communication internal module. The USB cable 14 can be another I/F. The direct-printing function is a function for printing a still image file by directly sending the still image file from the digital camera 200 to the printer device 21 without using a PC and the like, regardless of a wireless communication or wired communication.

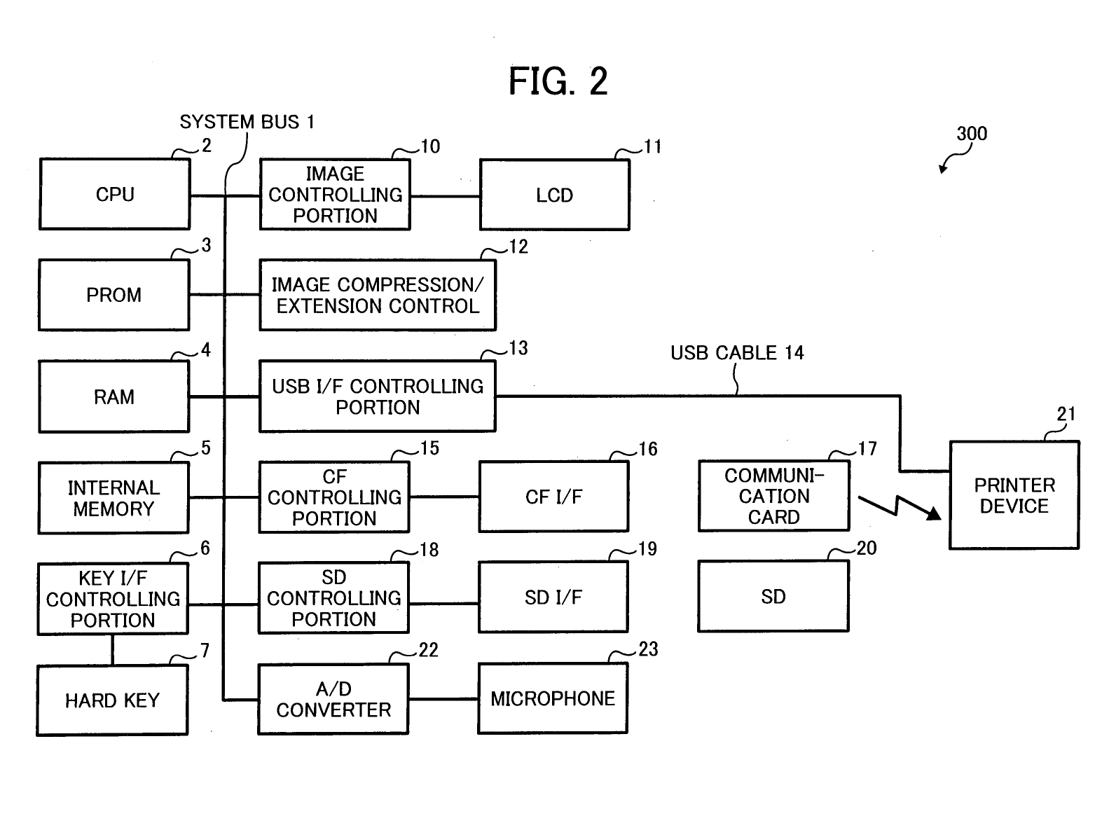

FIG. 2 is a block diagram showing hardware of a PDA device according to one embodiment of the present invention. In FIG. 2, structural elements similar to the structural elements shown in FIG. 1 are explained by the same reference numerals. A difference between FIG. 1 and FIG. 2 is that the camera controlling portion 8 and the camera portion 9 are not included in FIG. 2.

Next, operations of a PDA device 300 will be described. Image information is loaded into the PDA device 300 via an image file stored in an SD card 20 or a communication card 17. The image file loaded via the communication card 17 can be stored in the SD card 20 or an internal memory 5. In addition, the image information loaded into the PDA device is extended by using an image compression/extension controlling portion 12, and then is displayed onto an LCD 11 via an image controlling portion 10. The image information displayed onto the LCD 11 is compressed by the image compression/extension controlling portion 12 after a required process has been carried out, and then is again stored in the SD card 20 or the internal memory 5.

Voice information is input from a microphone 23 by a voice memo function. The input voice information is converted into digital data by an A/D converter 22, and the digital data is stored into the SD card 20 or the internal memory 5. The stored voice data is controlled as a voice memo. A voice memo can be selected from a plurality of voice memos by an operation of a user. When the image information displayed onto the LCD 11 is again stored in the SD card 20 or the internal memory 5, the selected voice memo data is written into a header portion as the voice memo data in a portion for conducting a required header process, and is recorded into the internal memory 5 or the SD card 20 via an SD controlling portion 18 together with the loaded image information, or when the image information is recorded into the internal memory 5 or the SD card 20 via the SD controlling portion 18, the selected voice memo data is recorded in the internal memory 5 or the SD card 20 via the SD controlling portion 18 as another file as being related to the photographed image.

Moreover, a direct-printing function is for directly printing a still image file stored in the internal memory 5 or the SD card 20 by a printer device 21 via the communication card 17 inserted into a CF I/F 16 or via the USB cable 14 without using a PC and the like. The communication card 17 inserted into the CF I/F 16 can be included in the digital camera as a communication internal module. Moreover, the USB cable 14 can be another I/F. Regardless of wireless communication or wired communication, the direct-printing function is a function for directly sending the still image file from the digital camera to the printer device 21 so as to print the still image file by the printer device 21.

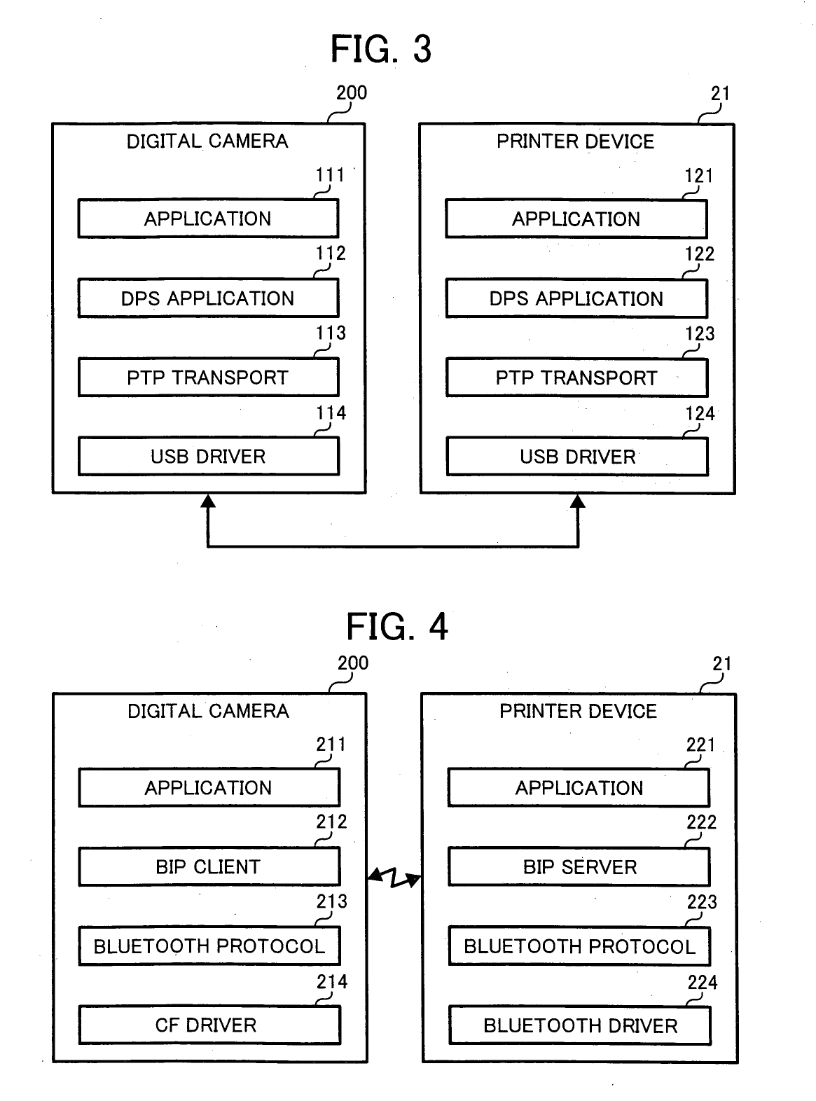

FIG. 3 is a block diagram illustrating software of the digital camera 200 according to one embodiment of the present invention.

The software of the digital camera 200 comprises an application 111, DPS (Direct Printing Service) application 112, PTP (Picture Transfer Protocol) transport 113 and USB driver 114. The printer device 21 comprises an application 121, DPS (Direct Printing Service) application 122 and PTP (Picture Transfer Protocol) transport 123 and USB driver 124. The present embodiment shows a software structure when conforming to Pict Bridge standard, one of the direct-printing standards with a wired communication via an USB.

FIG. 4 is a block diagram showing software of the digital camera 200 according to one embodiment of the present invention. Structural elements similar to the structural elements shown in FIG. 3 are explained by using the same reference numerals. The software of the digital camera 200 comprises an application 211, BIP (Basic Image Profile) client 212, Bluetooth protocol 213 and CF driver 214. The printer device 21 comprises an application 221, BIP (Basic Image Profile) server 222, Bluetooth protocol 223 and Bluetooth driver 224. The present embodiment shows a software structure when conforming to Bluetooth standard, one of the direct-printing standards via a wireless communication card.

In addition, the typical standards with wired and wireless communications are presented as the software structures. However, the direct-printing can be achieved by another standard, and also the direct-printing can be achieved by an original method.

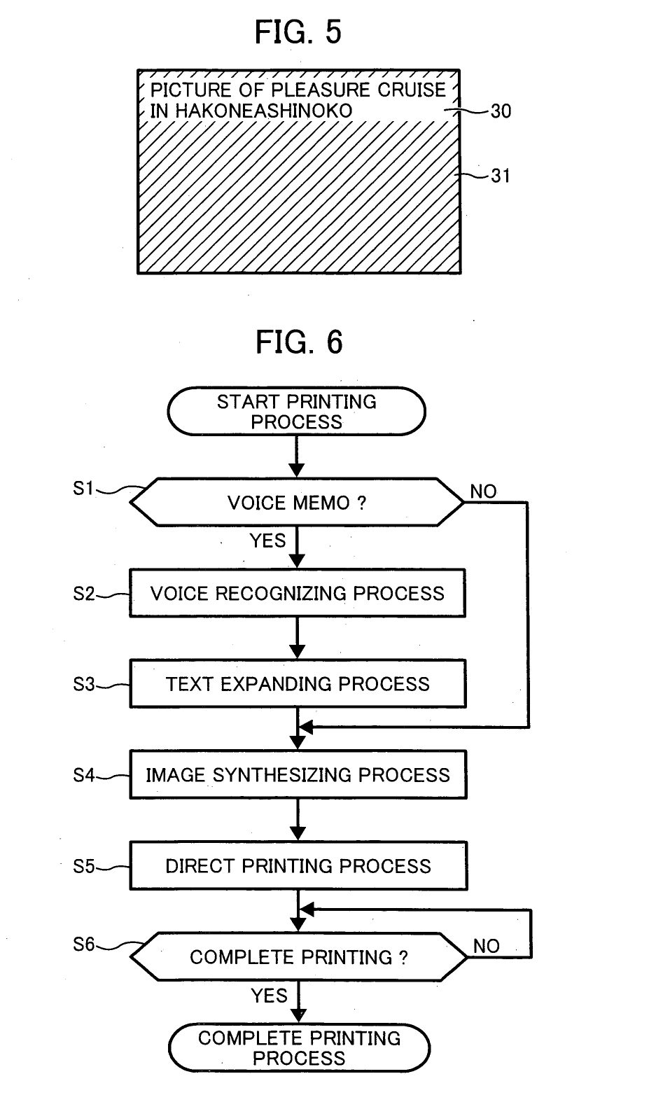

FIG. 5 is a view illustrating a printed example according to a first embodiment of the present invention. In FIG. 5, for example, “picture of pleasure cruise in Hakoneashinoko” is printed as image data, and a picture of a pleasure cruise in Hakoneashinoko is printed therebelow.

FIG. 6 is an operation flowchart according to the first embodiment of the present invention. At first, when a printing process is started, presence of a voice memo is determined (S1). When a voice memo is included, a voice reorganizing process is performed to the voice information (S2), and then text information is expanded in the RAM 4 (S3). Dictionary information required for recognizing voice can be implemented in a PROM 3 as a program, or can be stored in the internal memory 5 and a detachable external memory such as the SD 20. A Kana-Kanji conversion process can be performed for the expanded text information so as to format the expanded text information. The expanded text information can only include Kana information. Next, the expanded text information is converted into bitmap information, and the bitmap information and the image information to be printed are synthesized as shown in FIG. 5 (S4) so as to obtain one still image file. After obtaining the still image file, the direct-printing is performed to the external printer device (S5). When the printing is completed (S6), the printing process is completed.

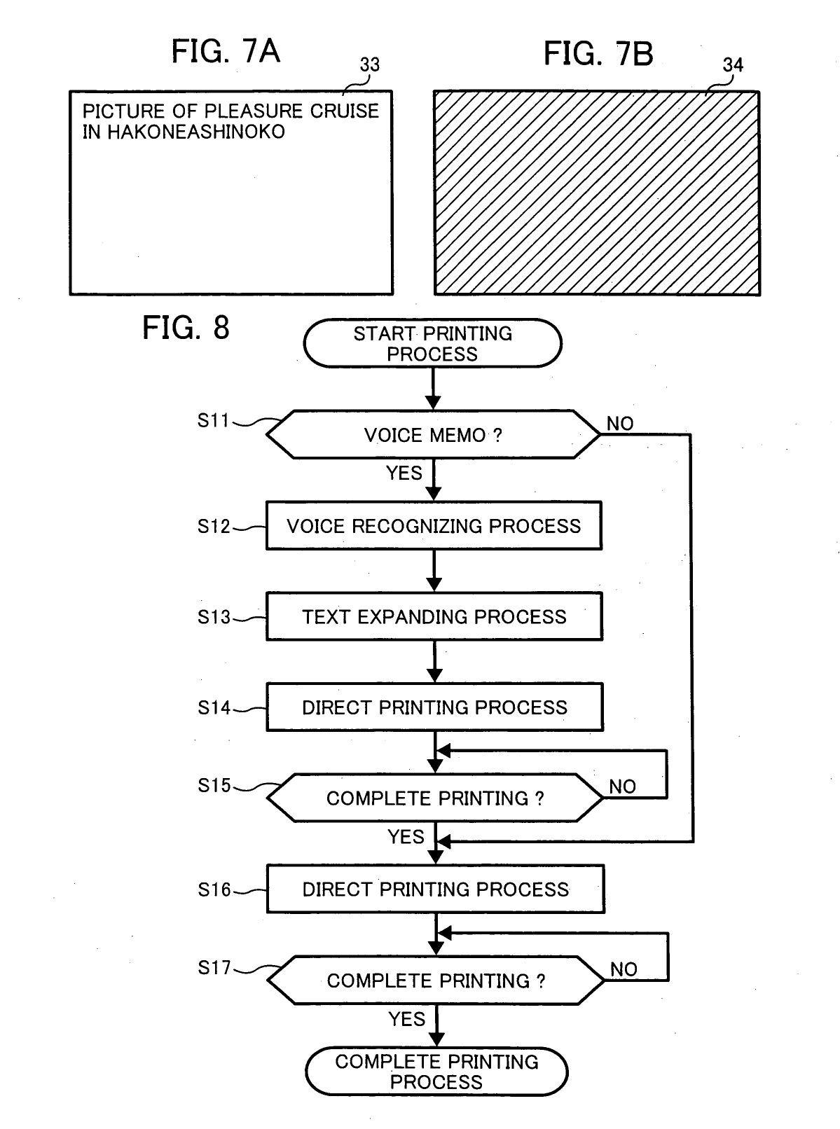

FIGS. 7A, 7B are views showing printed examples according to a second embodiment of the present invention. In FIG. 7A, for example, “picture of pleasure cruise in Hakoneashinoko” is printed as image data. In FIG. 7B, a picture of a pleasure cruise in Hakoneashinoko is printed.

FIG. 8 shows a flowchart according to the second embodiment of the present invention. At first, when a printing process is started, presence of a voice memo is determined (S11). When a voice memo is included, a voice recognizing process is carried out to the voice information (S12), and then text information is expanded in the RAM 4 (S13). Dictionary information required for recognizing voice can be implemented in the PROM 3 as a program, or can be stored in the internal memory 5 and a detachable external memory such as the SD 20. In addition, a Kana-Kanji conversion process can be performed for the expanded text information so as to format the expanded text information. The expanded text information can only include Kana information. Next, the expanded text information is converted into bitmap information to obtain one text file as shown in FIG. 7A. After obtaining the text file, the direct-printing is performed to the external printer device 21 (S14). When the printing is completed (S15), the direct-printing process is performed to the external printer device 21 so as to print the still image file of next printing object (S16). When the printing is completed (S17), the printing process is completed.

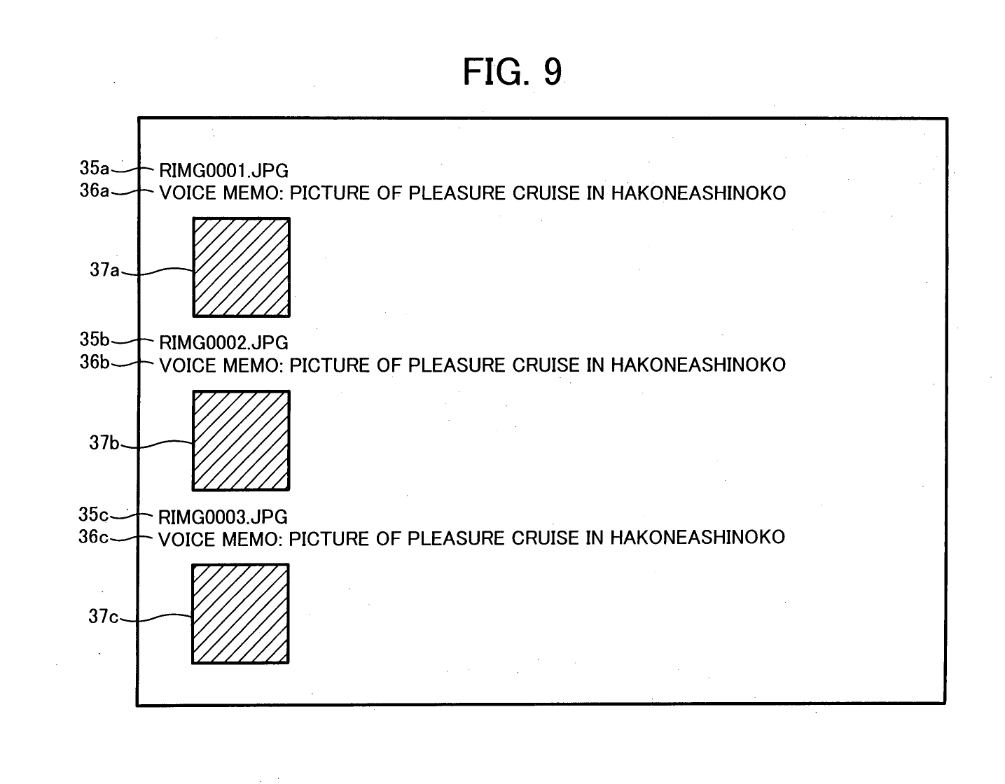

FIG. 9 is a view showing a printed example according to a third embodiment of the present invention. In FIG. 9, “RIMG0001.JPG” 35a is printed on the top as a file name, “picture of pleasure cruise in Hakoneashinoko” 36a is printed as a voice memo, and a picture of a pleasure cruise in Hakoneashinoko 37a is printed therebelow, for example. Respective voice memos and pictures for two types of files “RIMG0002.JPG” 35b and “RIMG0003.JPG” 35c are printed below the picture 37a similar to the above.

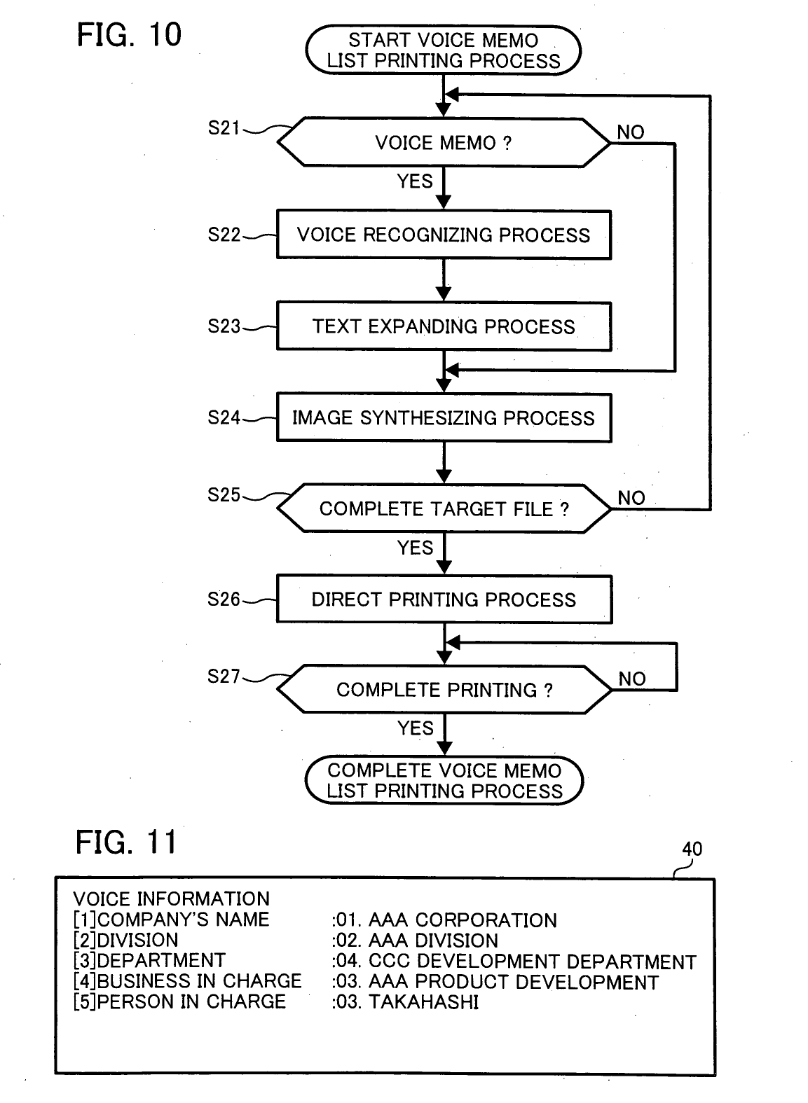

FIG. 10 shows a flowchart according to the third embodiment of the present invention. When a voice memo list printing process is started, presence of a voice memo is determined (S21). When a voice memo is included, a voice recognizing process is carried out to the voice information (S22), and then text information is expanded in the RAM 4 (S23). Dictionary information required for recognizing voice can be implemented in the PROM 3 as a program, or can be stored in the external memory 5 or a detachable external memory such as the SD 20. In addition, a Kana-Kanji conversion process is performed to the expanded text information so as to format the expanded text information. The expanded text information can only include Kana information. Next, the expanded text information is converted into bitmap information, and the bitmap information and the image information to be printed are synthesized as shown in FIG. 9 (S24). Next, a target file is determined whether it is the last file or not (S25). When the target file is not the last file, the process is repeated from the determination of presence of a voice memo in step S21. When the repeated process is completed to all of the target files, the direct-printing is performed to the external printer device 21 so as to print the completed voice memo list (S26). When the printing is completed (S27), the voice memo list printing process is completed.

FIG. 11 is a view showing a printed example according to a fourth embodiment of the present invention. In a printed example 40, (1) company's name, (2) division, (3) department, (4) business in charge and (5) person in charge are respectively printed as voice information.

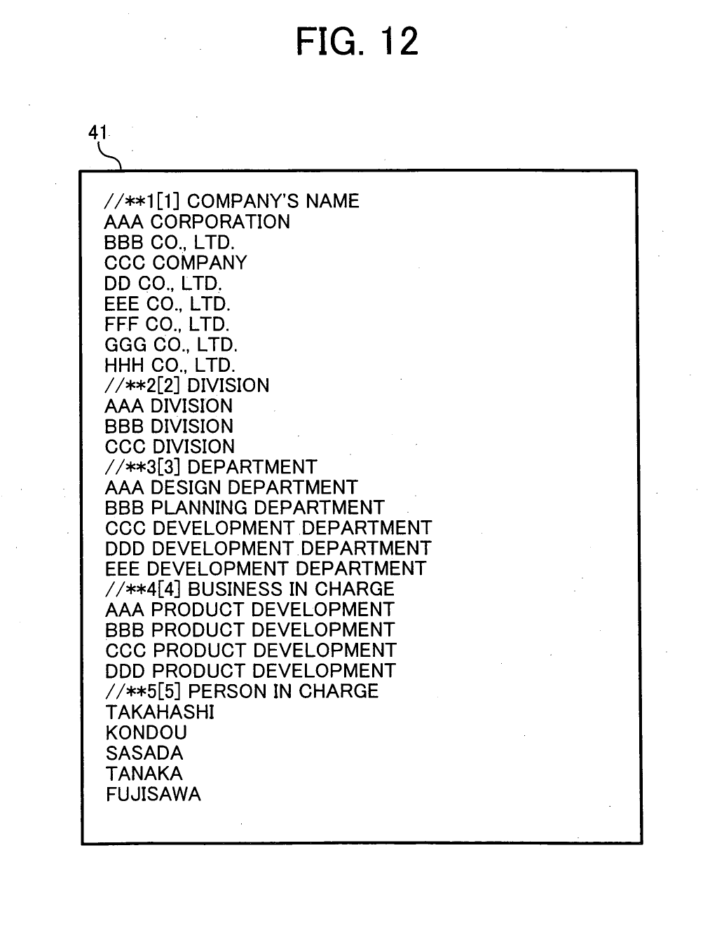

FIG. 12 is a view illustrating a keyword table for recognizing voice according to the fourth embodiment of the present invention. In a keyword table 41, company's names, divisions, departments, businesses in charge and people in charge are listed, for example.

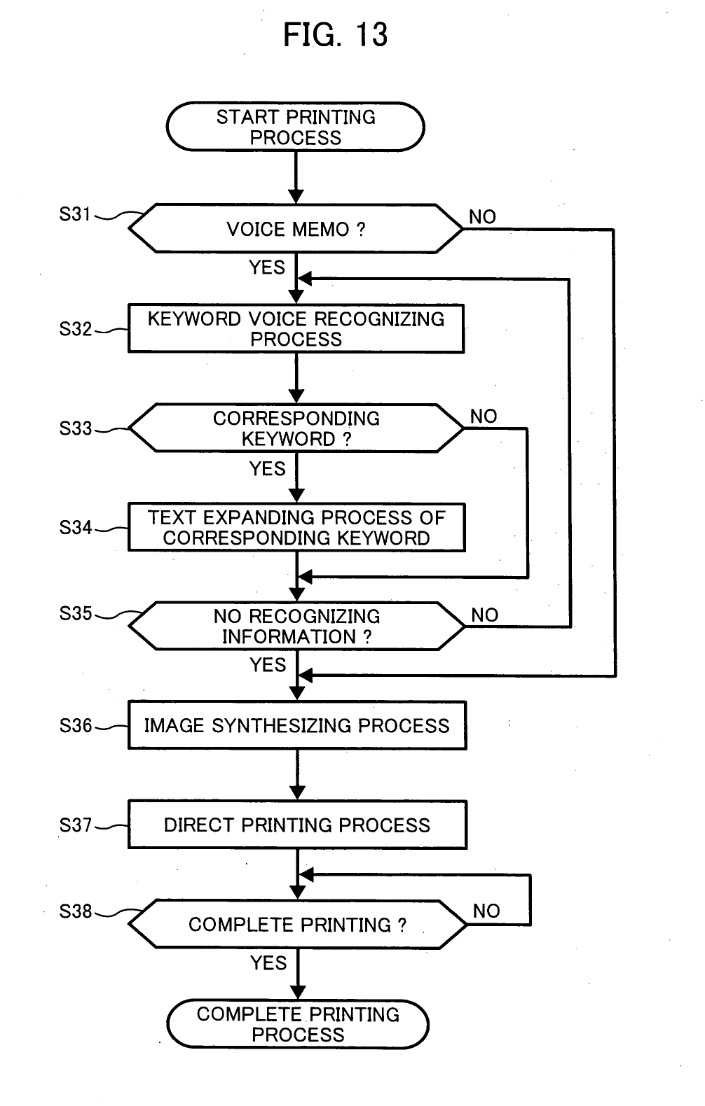

FIG. 13 shows a flowchart according to the fourth embodiment of the present invention. The keywords for recognizing voice shown in FIG. 11 are previously registered in the digital camera 200 or the PDA device 300. When registering the keywords, the keywords can be edited by an external device to be loaded into the system through the SD card 20 or the communication card 17. The keywords can be composed in the system by using the digital camera device, the LCD display portion of the PDA device and hard keyboard. An image to be photographed, information for discriminating a photographer and the like are registered in the keywords for recognizing voice. At first, when a printing process is started, presence of a voice memo is determined (S31). When a voice memo is included, a keyword voice recognizing process is performed to the voice information (S32). In the keyword voice recognizing process, it is determined whether the information recognized from the voice information corresponds to the registered keyword or not (S33). When the recognized information corresponds to the registered keyword, the text information of the corresponding keyword is expanded in the RAM 4 (S34). Dictionary information required for recognizing voice can be implemented in the PROM 3 as a program, or can be stored in the internal memory 5 or a detachable external memory such as the SD 20. In addition, a Kana-Kanji conversion process can be performed to the expanded text information so as to format the expanded text information. The expanded text information can only include Kana information. The printing process is repeated from the keyword voice recognizing process to all of the recognized information (S35). Next, the expanded text information is converted into bitmap information, and the bitmap information and the image information to be printed are synthesized as shown in FIG. 11 (S36) so as to obtain one still image file. After obtaining the still image file, the direct-printing is performed to the external printer device 21 (S37). When the printing is completed (S38), the printing process is completed.

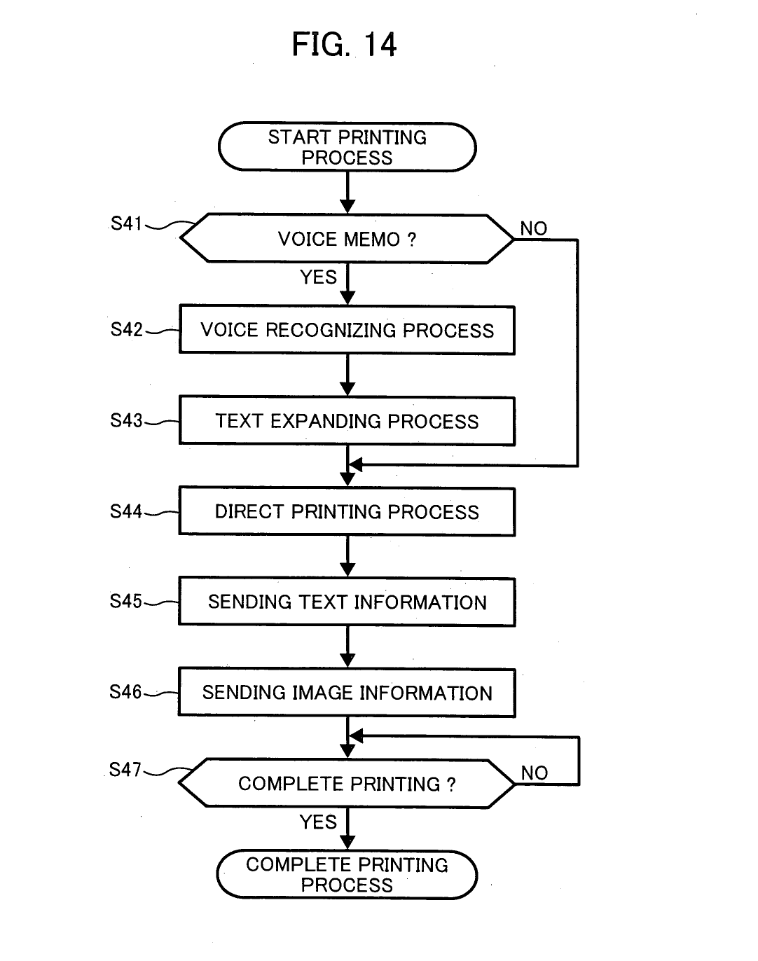

FIG. 14 shows a flowchart according to a fifth embodiment of the present invention. When a printing process is started, presence of a voice memo is determined (S41). When a voice memo is included, a voice recognizing process is carried out to the voice information (S42), and then text information is expanded in the RAM 4 (S43). Dictionary information required for recognizing voice can be implemented in the PROM 3 as a program, or can be stored in the internal memory 5 and a detachable external memory such as the SD 20. Moreover, a Kana-Kanji conversion process or the like is performed to the expanded text information to format the expanded text information. The expanded text information can only include Kana information. When the expansion of the voice information is completed, direct-printing is performed to the external printer device (S44). At first, the text information in which the voice information is expanded is sent to the external printer (S45). Next, a still image file is sent to the external printer (S46). When the sending is completed, the text information and the still image file are synthesized in the external printer to be printed. When the printing is completed (S46), the printing process is completed.

What is claimed is:

1. A digital imaging device including a communication device configured to send a still image file to an image forming device to be directly printed out, comprising:
a voice information obtaining device configured to obtain voice information corresponding to the still image file recorded in a recording medium;
a text conversion device configured to apply a voice recognizing process to the voice information obtained by the voice information obtaining device so as to convert the voice information into text information;
a image data composing device configured to compose image data of the text information based on the text information converted by the text conversion device; and
a synthesizing device configured to synthesize the image data composed by the image data composing device and the still image file, wherein
the communication device sends the still image file synthesized by the synthesizing device to the image forming device to be directly printed out.

2. A digital imaging device including a communication device configured to send a still image file to an image forming device to be directly printed out, comprising:
a voice information obtaining device configured to obtain voice information corresponding to the still image file recorded in a recording medium;
a text conversion device configured to apply a voice reorganizing process to the voice information obtained by the voice information obtaining device so as to convert the voice information into text information;
an image data composing device configured to compose image data of the text information based on the text information converted by the text conversion device; and
a communication device configured to output the image data composed by the image data composing device to an external device, wherein
the communication device sends the still image file to the image forming device to be directly printed out after the communication device has sent the image data composed by the image data composing device to the image forming device to be directly printed out.

3. A digital imaging device including a communication device configured to send a still image file to an image forming device to be directly printed out, comprising:
a voice information obtaining device configured to obtain voice information corresponding to a plurality of still image files recorded in a recording medium;
a text conversion device configured to apply a voice recognizing process to the plurality of voice information obtained by the voice information obtaining device so as to convert the plurality of voice information into the text information;
an image data composing device configured to compose image data of the text information based on the plurality of text information converted by the text conversion device; and
a synthesizing device configured to synthesize the plurality of image data composed by the image data composing device and the plurality of still image files, wherein
the communication device sends all of the plurality of still image files synthesized by the synthesizing device to the image forming device to be directly printed out.

4. A digital imaging device including a communication device configured to send a still image file to an image forming device to be directly printed out, comprising:
a voice information obtaining device configured to obtain voice information corresponding to a plurality of still image files recorded in a recording medium;
a keyword registering device configured to register a keyword for recognizing voice;
a text conversion device configured to apply a voice recognizing process to the voice information obtained by the voice information obtaining device by using the keyword information registered by the keyword registering device so as to convert the voice information into the text information;
an image data composing device configured to compose image data of the text information based on the text information converted by the text conversion device; and
a synthesizing device configured to synthesize the image data composed by the image data composing device and the still image file, wherein
the communication device sends the still image file synthesized by the synthesizing device to the image forming device to be directly printed out.

5. A digital imaging device including a communication device configured to send a still image file to an image forming device to be directly printed out, comprising:
a voice information obtaining device configured to obtain voice information corresponding to a plurality of still image files recorded in a recording medium;
a text conversion device configured to apply a voice recognizing process to the voice information obtained by the voice information obtaining device so as to convert the voice information into text information; and
a sending device configured to send the still image file and the text information converted by the text conversion device, wherein
the image forming device includes a synthesizing device configured to synthesize the text information and the still image file, and the image forming device synthesizes the text information and the still image file sent from the sending device by the synthesizing device to print out the synthesized still image file.
